(19) United States
(12) Patent Application Publication
(10) Pub. No.: US 2014/0241435 A1
(43) Pub. Date: Aug. 28, 2014

(54) METHOD FOR MANAGING MEMORY, AND DEVICE FOR DECODING VIDEO USING SAME

(71) Applicants: Gwang Hoon Park, Seongnam-si (KR); Kyung Yong Kim, Suwon-si (KR)

(72) Inventors: Gwang Hoon Park, Seongnam-si (KR); Kyung Yong Kim, Suwon-si (KR)

(73) Assignee: INTELLECTUAL DISCOVERY CO., LTD., Suwon-si (KR)

(21) Appl. No.: 14/354,374

(22) PCT Filed: Dec. 13, 2011
(86) PCT No.: PCT/KR2011/009569

§ 371 Date: Apr. 25, 2014

Related U.S. Application Data
(60) Provisional application No. 61/551,441, filed on Oct. 26, 2011.

(30) Foreign Application Priority Data
Dec. 9, 2011 (KR) 10-2011-0131517

(51) Int. Cl. H04N 19/433; H04N 19/51

(52) U.S. Cl. CPC H04N 19/00515; H04N 19/00587
USPC 375/240.16

(57) ABSTRACT

The present invention relates to a method for managing memory, and to a device for decoding video using same. The method includes the marking of motion information stored in a first buffer in response to a memory management control command (MMCO), and the deleting of the motion information from the first buffer or the moving of the motion information to a second buffer in response to the marked information.

### TECHNICAL FIELD

The present invention concerns image processing techniques, and more specifically, to video coding methods and apparatuses of coding and decoding images.

### DISCUSSION OF RELATED ART

As HD (high definition) resolution (1280×1024 or 1920×1080) broadcast services being spread nationwide and worldwide, many users are being used to high-resolution, high-quality images, and many organizations are putting their utmost efforts to develop next-generation imaging apparatuses. Further, increased interest in UHD (Ultra High Definition) having four times as high resolution as HDTV, as well as HDTV, leads motion-picture standardization organizations to recognize the need of technology for compressing higher-resolution, higher-quality images. Further, there is a demand for new standards that may offer many benefits in view of frequency bandwidth or storage while providing the same quality as existing schemes through higher compression efficiency than current video compression encoding standards used for HDTVs or cell phones, i.e., H.264/AVC (Advanced Video Coding). Presently, the Moving Picture Experts Group (MPEG) and the Video Coding Experts Group (VCEG) are jointly on process for standardizing a next-generation video codec, High Efficiency Video Coding (HEVC). The HEVC aims to conduct encoding on images including UHD images with two times higher compression efficiency as compared with H.264/AVC. The HEVC may offer high-quality images, as well as HD or UHD images, and 3D broadcast at a lower frequency than that presently used over a mobile communication network.

Under the HEVC, spatial or temporal prediction may be performed on images, thus generating a prediction image. The difference between the original image and the prediction image may be coded. Such prediction coding may lead to an increase in image coding efficiency.

### SUMMARY

### Objects

An object of the present invention is to provide a video coding method and apparatus that may enhance coding/decoding efficiency.

### Solutions

To achieve the objects, according to an embodiment of the present invention, a method of managing a memory storing motion information comprises marking motion information stored in a first buffer according to a memory management control operation (MMCO) and deleting the motion information stored in the first buffer or moving the motion information to a second buffer according to the marked information.

According to an embodiment of the present invention, a video decoding apparatus comprises a first buffer storing motion information and a memory managing unit marking the motion information stored in the first buffer according to a memory management control operation (MMCO) and deleting the motion information stored in the first buffer or moving the motion information to a second buffer according to the marked information.

### Effects

According to an embodiment of the present invention, a memory storing motion information may be managed using a memory management control operation (MMCO), thus enhancing the memory efficiency on the motion information.

### BRIEF DESCRIPTION OF DRAWINGS

FIG. 1 is a block diagram illustrating a configuration of an image encoding apparatus according to an embodiment of the present invention.

FIG. 2 is a block diagram illustrating a configuration of an image decoding apparatus according to an embodiment of the present invention.

FIG. 3 is a block diagram illustration a partial configuration of a decoding apparatus according to an embodiment of the present invention.

FIG. 4 is a flowchart illustrating a method of managing a memory according to an embodiment of the present invention.

FIG. 5 is a view illustrating a configuration of a memory management control operation (MMCO) according to a first embodiment of the present invention.

FIG. 6 is a view illustrating an example method of managing a memory storing a reference picture according to a memory management control operation (MMCO).

FIG. 7 is a view illustrating a method of managing a memory storing motion information according to a memory management control operation (MMCO), in accordance with a first embodiment of the present invention.

FIG. 8 is a view illustrating a configuration of a memory management control operation (MMCO) according to a second embodiment of the present invention.

FIG. 9 is a view illustrating a method of managing a memory storing motion information according to a memory management control operation (MMCO), in accordance with a second embodiment of the present invention.

### DETAILED DESCRIPTION OF EMBODIMENTS

Hereinafter, embodiments of the present invention are described in detail with reference to the accompanying drawings. However, when determined to render the subject matter of the present invention unclear in describing embodiments of the present invention, the detailed description of known configurations or functions are not given.

When an element is “connected to” or “coupled to” another element, the element may be directly connected or coupled to the other element or other elements may intervene. When a certain element is “included,” other elements than the element are not excluded, and rather additional element(s) may be included in an embodiment or technical scope of the present invention.

The terms “first” and “second” may be used to describe various elements. The elements, however, are not limited to the above terms. In other words, the terms are used only for distinguishing an element from others. Accordingly, a “first element” may be named a “second element,” and vice versa.

Further, the elements as used herein are shown independently from each other to represent that the elements have respective different functions. However, this does not immediately mean that each element cannot be implemented as a piece of hardware or software. In other words, each element is shown and described separately from the others for ease of description. A plurality of elements may be combined and operate as a single element, or one element may be separated into a plurality of sub-elements that perform their respective operations. Such also belongs to the scope of the present invention without departing from the gist of the present invention.

Further, some elements may be optional elements for better performance rather than necessary elements to perform essential functions of the present invention. The present invention may be configured only of necessary elements. And the present invention may be configured only of necessary elements except for the optional elements such as enhancing performance.

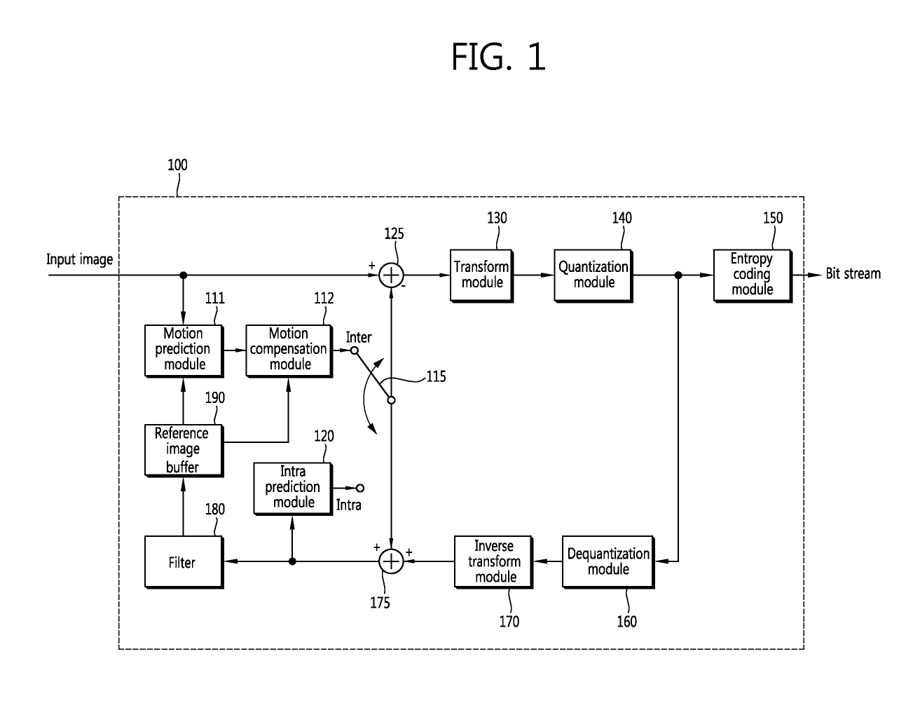

FIG. 1 is a block diagram illustrating a configuration of an image encoding apparatus according to an embodiment of the present invention.

Referring to FIG. 1, the image encoding apparatus 100 includes a motion prediction module 111, a motion compensation module 112, an intra prediction module 120, a switch 115, a subtractor 125, a transform module 130, a quantization module 140, an entropy-coding module 150, an Dequantization module 160, an inverse-transform module 170, an adding module 175, a filter module 180, and a reference image buffer 190.

The image encoding apparatus 100 conducts coding on an input image in intra mode or inter mode to thereby output a bit stream. Intra prediction means intra-frame prediction, and inter prediction means inter-frame prediction. In intra mode, the switch 115 switches to ‘intra’ and in inter mode, the switch 115 switches to ‘inter.’ The image encoding apparatus 100 generates a prediction block on an input block of the input video and then codes a difference between the input block and the prediction block.

In intra mode, the intra prediction module 120 generates a prediction block by performing spatial prediction using a pixel value of an already coded block positioned adjacent to the current block.

In inter mode, the motion prediction module 111 discovers an area of a reference image stored in the reference image buffer 190 that well matches the input block in the process of motion prediction, thereby obtaining a motion vector. The motion compensation module 112 conducts motion compensation using the motion vector, thus generating a prediction block.

The subtractor 125 generates a residual block based on a difference between the input block and the generated prediction block. The transform module 130 conducts transformation on the residual block to thereby output a transform coefficient. The quantization module 140 quantizes the input transform coefficient according to a quantization parameter to thereby output a quantized coefficient. The entropy-coding module 150 entropy-codes the input quantized coefficient according to a probability distribution, thus outputting a bit stream.

The HEVC conducts inter prediction coding, i.e., inter-frame prediction coding, and thus, the currently coded image needs to be decoded and stored to be used as a reference image. Accordingly, the quantized coefficient is dequantized by the de-quantization module 160 and is inverse-transformed by the inverse-transform module 170. The inverse-quantized, inverse-transformed coefficient is added to the prediction block by the adding module 175, and a reconstructed block is thereby generated.

The reconstructed block goes through the filter 180 that may then apply at least one or more of a deblocking filter, an Sample Adaptive Offset (SAO), and an Adaptive Loop Filter (ALF) to the reconstructed block or reconstructed picture. The filter 180 may also be called an adaptive in-loop filter. The deblocking filter may rid a block distortion created at the boundary between the blocks. The SAO may add a proper offset value to a pixel value in order to compensate for a coding error. The ALF may conduct filtering based on a value obtained by comparing the reconstructed image with the original image. The ALF may be performed only when high efficiency is needed. After undergoing the filter 180, the reconstructed block is stored in the reference image buffer 190.

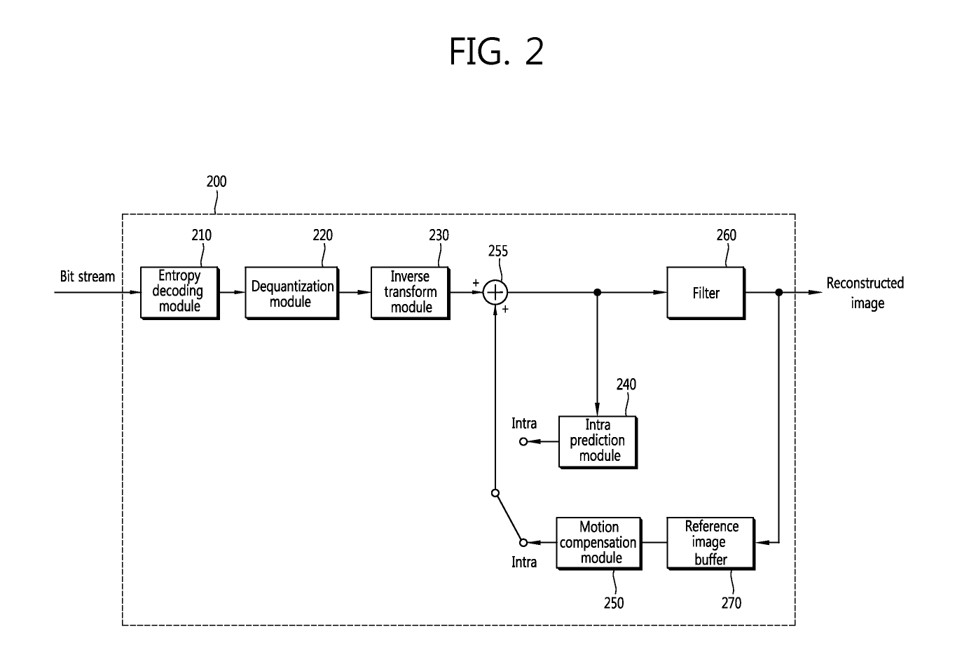

FIG. 2 is a block diagram illustrating a configuration of an image decoding apparatus according to an embodiment of the present invention.

Referring to FIG. 2, the image decoding apparatus 200 includes an entropy-decoding unit 210, an inverse-quantization module 220, an inverse-transform module 230, an intra prediction module 240, a motion compensation module 250, a filter 260, and a reference image buffer 270.

The image decoding apparatus 200 receives the bit stream output from the encoding apparatus, decodes the bit stream in intra mode or inter mode, and outputs a reconstructed image, i.e., a restored image. In intra mode, the switch switches to “intra,” and in inter mode, the switch switches to “inter.” The image decoding apparatus 200 obtains a residual block from the received bit stream, generates a prediction block, and adds the residual block and the prediction block, thus generating a reconstructed block, i.e., restored block.

The entropy-decoding unit 210 decodes the received bit stream according to a probability distribution, outputting a quantized coefficient. The quantized coefficient is dequantized by the dequantization module 220 and is inverse-transformed by the inverse-transform module 230. As a result of inverse-quantizing and inverse-transforming the quantized coefficient, a residual block is generated.

In intra mode, the intra prediction module 240 conducts spatial prediction using a value of a pixel in an already coded block adjacent to the current block, thus generating a prediction block.

In inter mode, the motion compensation module 250 performs motion compensation using the reference image stored in the reference image buffer 270 and a motion vector, thus generating a prediction block.

The residual block and the prediction block are added by the adding module 255, and the added blocks go through the filter 260. The filter 260 may apply at least one or more of a deblocking filter, an SAO, and an ALF to the reconstructed block or reconstructed picture. The filter 260 outputs a reconstructed image, i.e., a restored image. The restored image is stored in the reference image buffer 270 and may be used for inter prediction.

As methods for enhancing prediction performance of the encoding/decoding apparatuses, there are a method of raising accuracy of interpolated images and a method of predicting a difference signal. As used herein, the term “difference signal” denotes a signal representing a difference between an original image and a prediction image. As used herein, the term “difference signal” may be interchangeably used with a “residual”, “differential signal,” “residual block,” or “differential block,” according to contexts, and those terms may be distinguished by those of ordinary skill in the art within the range of not affecting the scope or gist of the present invention.

Even when the interpolated image has more accuracy, the difference signal is forced to be generated. Accordingly, encoding performance needs to be enhanced by minimally reducing the difference signal to be coded by increasing the prediction performance of the difference signal.

To predict a difference signal, a filtering method using a fixed filter coefficient may be used. However, the prediction performance of the filtering method is limited by the fact that filter coefficients cannot be adaptively used depending on image characteristics. Accordingly, it needs to be enhanced prediction accuracy by enabling filtering to be performed to fit the characteristics of each prediction block.

Hereinafter, “block” means a unit of image encoding and decoding. Upon image encoding and decoding, the unit of coding or decoding refers to each of the units to which one image is separated, and may be thus referred to as macro block, coding unit (CU), prediction unit (PU), transform unit (TU), or transform block. One block may be split into sub blocks having smaller size.

Meanwhile, the reference pictures stored in the reference image buffer 270 of the image decoding apparatus 200 may be deleted or moved to another buffer according to a memory management control operation (MMCO).

According to an embodiment of the present invention, the memory storing motion information of the image decoding apparatus 200 is also managed according to the memory management control operation (MMCO), and the motion information stored in a buffer may be deleted or moved to another buffer by the memory management control operation (MMCO).

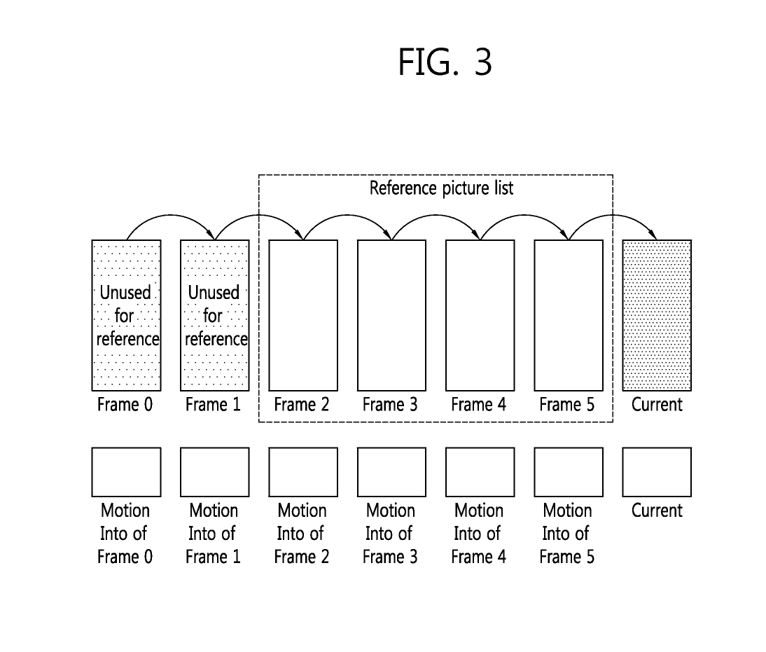

Hereinafter, a memory management method and a decoding apparatus using the same, according to an embodiment of the present invention, are described in greater detail. Meanwhile, description of the same elements as those described in connection with FIGS. 1 and 2, among the elements shown in FIGS. 3 to 9, is omitted.

FIG. 3 is a block diagram illustrating a partial configuration of a decoding apparatus according to an embodiment of the present invention. The image decoding apparatus 200 may include a memory managing module 280, a first buffer 275, and a second buffer 276.

Referring to FIG. 3, the first buffer 275 may store motion information of reference pictures previously reconstructed. For example, the first buffer 275 may be implemented in a memory such as the reference image buffer 270 storing the reference pictures or may be implemented as a separate memory.

Meanwhile, the memory managing module 280 marks motion information stored in the first buffer 275 according to a memory management control operation (MMCO), and according to the marked information, may delete the motion information stored in the first buffer 275 or move the motion information to the second buffer 276.

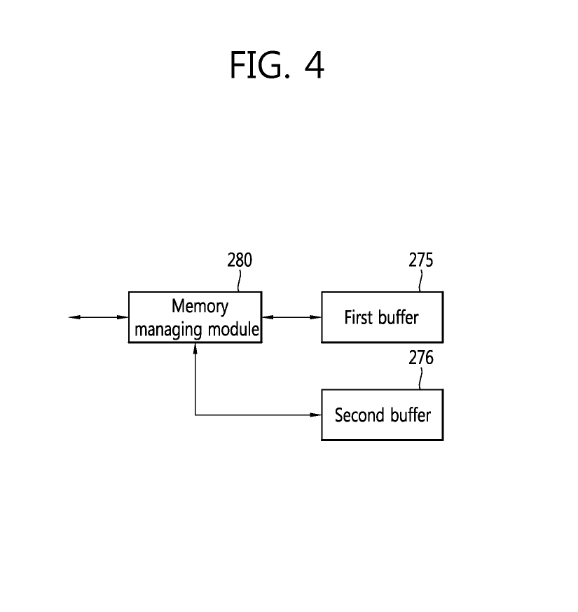

FIG. 4 is a flowchart illustrating a method of managing a memory according to an embodiment of the present invention. The memory management method is described in detail in association with the block diagram illustrating a configuration of a decoding apparatus as shown in FIG. 3, according to an embodiment of the present invention.

Referring to FIG. 4, the memory managing module 280 marks motion information stored in the first buffer 275 according to a memory management control operation (MMCO) (step S300).

The memory managing module 280 identifies the marked information (S310) and deletes the motion information stored in the first buffer 275 (step S310) or moves the motion information to the second buffer 276 (step S320).

The memory managing module 280, in case the memory management control operation (MMCO) is obtained from the current frame in the process of decoding the current frame, may manage the first buffer 275 storing the motion information so as to correspond to the memory management control operation (MMCO).

For example, the memory management control operation (MMCO) may be to manage the reference image buffer 270 storing reference pictures as one for a reference picture.

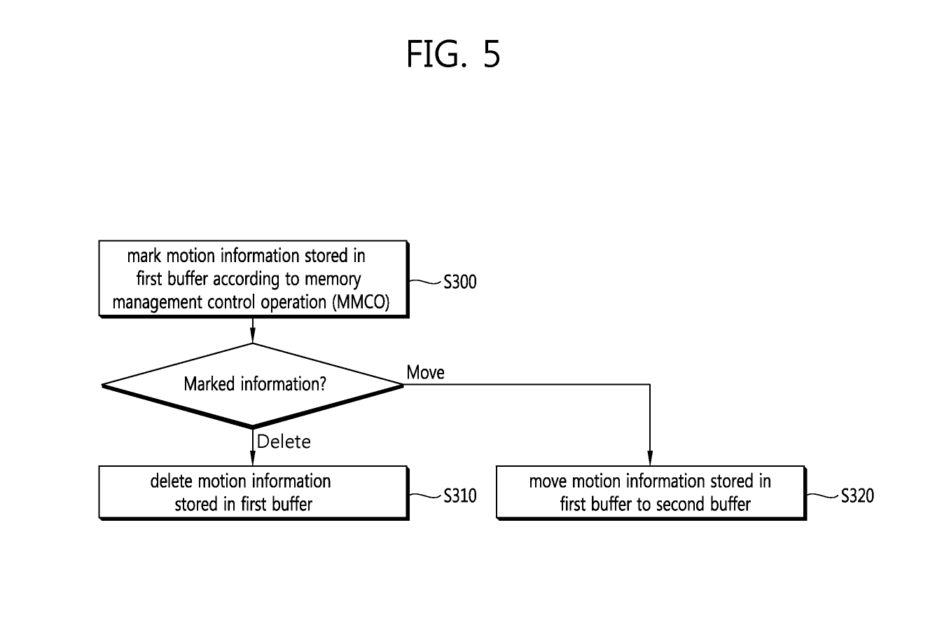

Referring to FIG. 5, a memory management operation by the memory managing unit 280 according to code numbers of the memory management control operation (MMCO) is described in detail.

First, the code number of the memory management control operation (MMCO) being ‘0’ denotes ‘terminate the memory management,’ and the code number of the memory management control operation (MMCO) being ‘1’ denotes ‘mark a short-term reference picture as an unused reference picture.’

Further, the code number of the memory management control operation (MMCO) being ‘2’ denotes ‘mark a long-term reference picture as an unused reference picture,’ and the code number of the memory management control operation (MMCO) being ‘3’ denotes ‘mark a short-term reference picture as a long-term reference picture and then move it to a long-term reference buffer.’

The code number of the memory management control operation (MMCO) being ‘4’ relates to determining the size of the long-term reference buffer, and the code number of the memory management control operation (MMCO) being ‘5’ denotes ‘mark all reference pictures as an unused reference picture and reset all content in the buffer.’

Finally, the code number of the memory management control operation (MMCO) being ‘6’ denotes ‘mark a current picture as a long-term reference picture and store it in a long-term reference buffer.’

Meanwhile, a reference picture marked as the unused reference picture may be deleted from the reference image buffer 270.

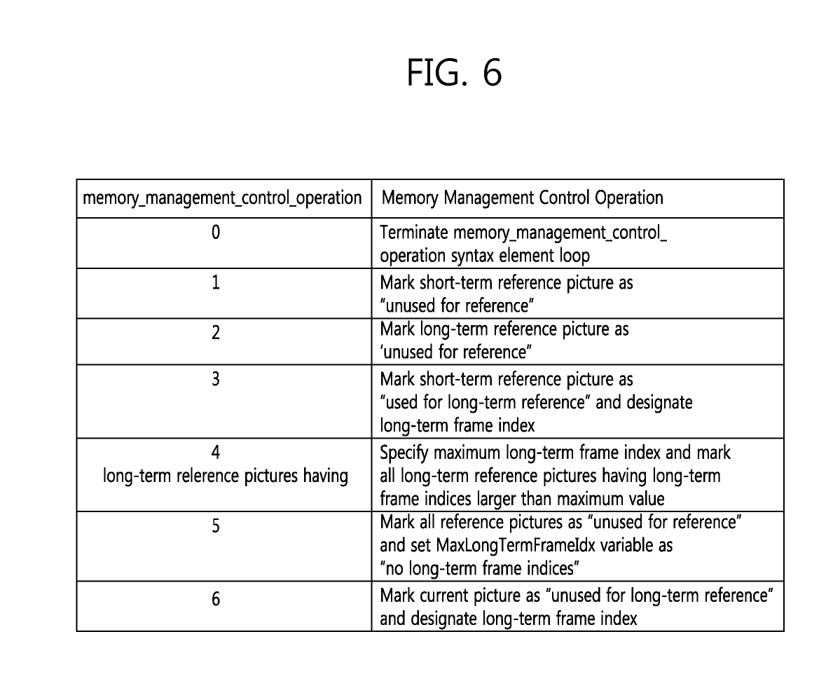

Referring to FIG. 6, the memory managing unit 280 may delete a reference picture corresponding to ‘Frame 0’ and a reference picture corresponding to ‘Frame 1’ from the reference image buffer 270 marked as an unused reference picture according to syntaxes of the above-described memory management control operation (MMCO).

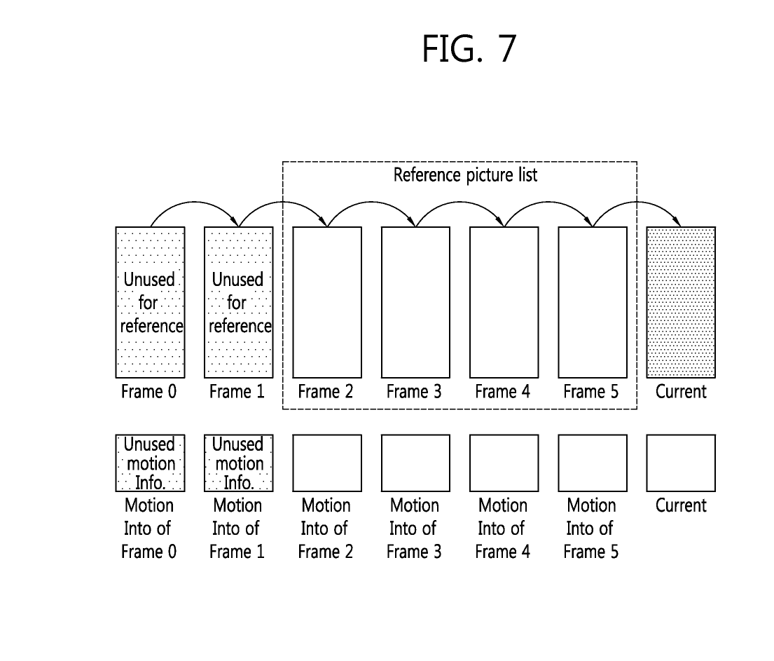

Meanwhile, as shown in FIG. 7, the memory managing unit 280 may delete, from the first buffer 275, motion information owned by the deleted reference pictures, e.g., motion information of ‘Frame 0’ and motion information of ‘Frame 1’ according to the syntaxes of the memory management control operation (MMCO) for the reference picture.

Further, according to the syntaxes of the memory management control operation (MMCO), a specific short-term reference picture may be moved to the long-term reference buffer, and accordingly, motion information owned by the specific short-term reference picture may be moved from the first buffer 275 to the second buffer 276.

In such case, among the motion information stored in the first buffer 275, unnecessary motion information may be deleted or may remain stored without being moved to the second buffer 276. In other words, motion information on all the frames included in the reference picture list may be left to be stored in the first buffer 275.

Accordingly, in coding/decoding a high-resolution image such as an FHD or higher, 4 k×2 k image, memory may be unnecessarily wasted, thus leading to a significantly increased memory volume.

According to an embodiment of the present invention, the memory managing module 280 may manage the first buffer 275 storing motion information using the memory management control operation (MMCO) for reference picture, as is, as described above in connection with FIGS. 5 and 6.

For example, motion information necessary for coding or decoding a current frame is motion information for a reference picture immediately prior to the current frame in the case of low delay and may be motion information for the reference picture immediately before the current frame and reference pictures after the current frame (or motion information for frames decoded earlier than the current frame) in the case of random access.

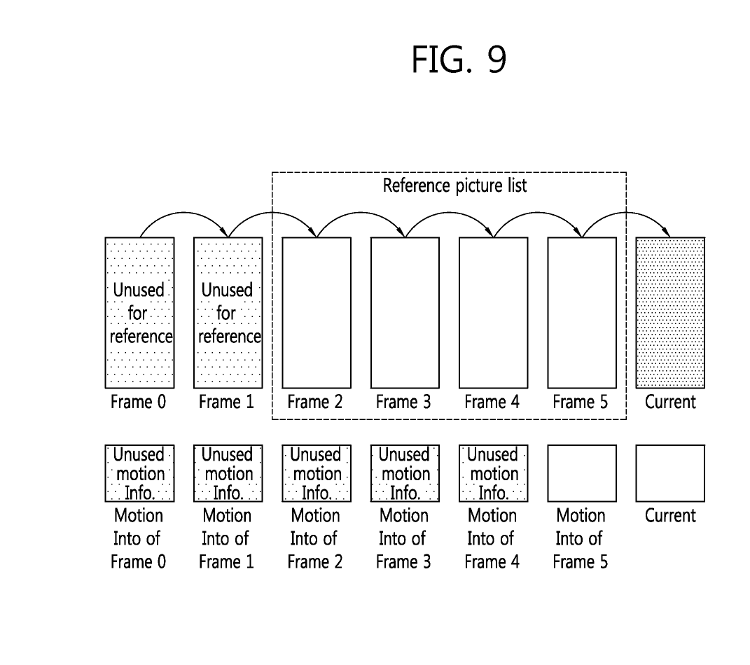

Accordingly, in the case of low delay, the memory managing module 280 may delete the motion information other than the motion information for the reference picture immediately before the current frame from the first buffer 275 using the memory management control operation (MMCO) syntax for reference picture, as shown in FIG. 9.

Further, in the case of random access, the memory managing module 280 may delete from the first buffer 275 motion information other than the motion information for the reference picture immediately before the current frame and reference pictures after the current frame (motion information on a frame that is not used as reference picture afterwards) using the memory management control operation (MMCO) syntax for reference picture.

According to another embodiment of the present invention, the memory management control operation (MMCO) is one for motion information, and a memory management control operation (MMCO) syntax for motion information may be provided and fulfilled separately from the memory management control operation (MMCO) syntax for reference picture.

In such case, the motion information stored in the first buffer 275 may be managed by the memory management control operation (MMCO) syntax for motion information separately from deleting or moving the reference picture stored in the reference image buffer 270.

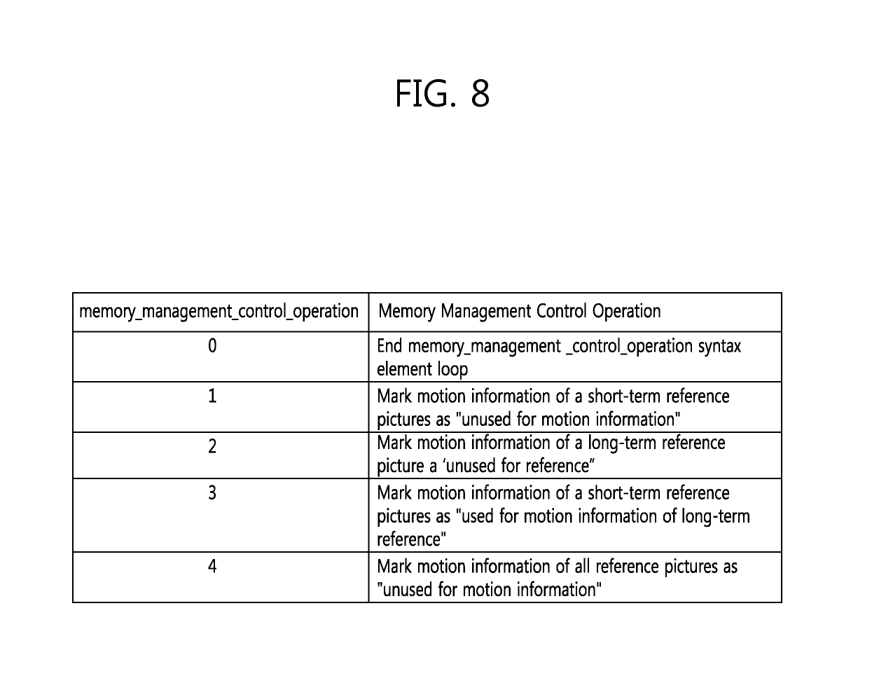

FIG. 8 illustrates a configuration of a memory management control operation (MMCO) for motion information according to an embodiment of the present invention.

Referring to FIG. 8, the code number of the memory management control operation (MMCO) for the motion information being ‘0’ denotes ‘terminate managing a memory storing motion information,’ and the code number of the memory management control operation (MMCO) being ‘1’ denotes ‘mark motion information of a short-term reference picture as unused motion information.’

Further, the code number of the memory management control operation (MMCO) being ‘2’ denotes ‘mark motion information of a long-term reference picture as unused motion information,’ and the code number of the memory management control operation (MMCO) being ‘3’ denotes ‘mark motion information of a short-term reference picture as motion information of a long-term reference picture and move it to a buffer storing motion information of the long-term reference picture (for example, second buffer 276).’

The code number of the memory management control operation (MMCO) being ‘4’ denotes ‘mark motion information of all reference pictures as unused motion information and reset all content of a buffer storing motion information (for example, first buffer 275).’

Meanwhile, the motion information marked as the unused motion information may be deleted from the first buffer 275.

Referring to FIG. 9, the memory managing module 280 may mark the motion information other than the motion information for a reference picture immediately before the current frame as unused motion information using the memory management control operation (MMCO) syntax for motion information as described above and may delete it from the first buffer 275.

Further, in the case of random access, the memory managing module 280 may delete from the first buffer 275 the motion information (motion information on a frame that is not used as reference picture afterwards) other than the motion information for the reference picture immediately before the current frame and reference pictures after the current frame using the memory management control operation (MMCO) syntax for motion information.

Although a video decoding method and apparatus according to an embodiment of the present invention has been described above, the video decoding method and apparatus may be implemented to perform a series of steps of a coding method as described above in connection with FIGS. 3 to 9.

Specifically, a video encoding method and apparatus according to an embodiment of the present invention may manage a memory storing motion information according to a memory management control operation (MMCO) as described above in connection with FIGS. 3 to 9.

Although in the above-described exemplary embodiments, methods are described based on flowcharts having a series of steps or blocks, the present invention is not limited to the order of the steps, and some steps may be conducted in a different order from other steps or simultaneously with the other steps. Further, it may be understood by one of ordinary skill in the art that the steps in the flowcharts do not exclude each other, and rather, other steps may be added thereto or some thereof may be removed therefrom without affecting the scope of the present invention.

Although the present invention has been shown and described with reference to embodiments thereof, it is understood by one of ordinary skill in the art that various changes in form and detail may be made thereto without departing from the scope of the present invention defined by the following claims.

1. A method of managing a memory storing motion information, the method comprising:
marking motion information stored in a first buffer according to a memory management control operation (MMCO); and
deleting the motion information stored in the first buffer or moving the motion information to a second buffer according to the marked information.

2. The method of claim 1, wherein the memory management control operation (MMCO) is for a reference picture having the motion information.

3. The method of claim 2, wherein the motion information stored in the first buffer is managed to correspond to deleting or moving the reference picture according to the memory management control operation (MMCO).

4. The method of claim 1, wherein the memory management control operation (MMCO) is for the motion information.

5. The method of claim 4, wherein the motion information stored in the first buffer is managed separately from deleting or moving the reference picture having the motion information.

6. The method of claim 4, wherein among the motion information stored in the first buffer, motion information other than motion information of a reference picture immediately before a current frame is deleted or moved to the second buffer.

7. The method of claim 4, wherein among the motion information stored in the first buffer, motion information other than motion information of a reference picture immediately before a current frame and motion information of two reference pictures after the current frame is deleted or moved to the second buffer.

8. An apparatus of decoding an image by performing motion compensation using motion information, the apparatus comprising:
a first buffer storing motion information; and
a memory managing module marking the motion information stored in the first buffer according to a memory management control operation (MMCO) and deleting the motion information stored in the first buffer or moving the motion information to a second buffer according to the marked information.

9. The apparatus of claim 8, wherein the memory managing module manages the motion information stored in the first buffer to correspond to deleting or moving the reference picture according to the memory management control operation (MMCO) for the reference picture having the motion information.

10. The apparatus of claim 8, wherein the memory managing module manages the motion information stored in the first buffer separately from deleting or moving the reference picture having the motion information according to the memory management control operation (MMCO) for the motion information.

11. The apparatus of claim 10, wherein the memory managing module deletes motion information other than motion information of a reference picture immediately before a current frame among the motion information stored in the first buffer or moves the other motion information to the second buffer.

12. The apparatus of claim 10, wherein the memory managing module deletes motion information other than motion information immediately before a current frame and motion information of two reference pictures after the current frame among the motion information stored in the first buffer or moves the other motion information to the second buffer.
